(19) United States
(12) Patent Application Publication
(10) Pub. No.: US 2009/0167150 A1
(43) Pub. Date: Jul. 2, 2009

(54) Field emission surface light source apparatus and method of fabricating the same

(76) Inventors: Ho-Suk Kang, Yongin-si (KR); Deuk-Seok Chung, Yongin-si (KR); Min-Jong Bae, Yongin-si (KR); Yong-Chul Kim, Yongin-si (KR)

Correspondence Address: ROBERT E. BUSHNELL & LAW FIRM, 2029 K STREET NW, SUITE 600, WASHINGTON, DC, 20006-1004, US

(21) Appl. No.: 12/232,169

(22) Filed: Sep. 11, 2008

(30) Foreign Application Priority Data
Dec. 28, 2007 (KR) 10-2007-0140672

(51) Int. Cl. H01J 1/62; H01J 9/14

(52) U.S. Cl. 313/502; 445/52

(57) ABSTRACT

Provided are a field emission surface light source apparatus and a method of fabricating the field emission surface light source apparatus. The field emission surface light source apparatus includes a base substrate and a transparent substrate facing each other, a plurality of gate electrodes formed on an upper surface of the base substrate, an insulating layer formed on the upper surface of the base substrate to cover the gate electrodes, a plurality of emitters formed on an upper surface of the insulating layer, and a fluorescent layer formed on a lower surface of the transparent substrate. The fluorescent layer faces the emitters.

### CLAIM OF PRIORITY

This application makes reference to, incorporates the same herein, and claims all benefits accruing under 35 U.S.C. §119 from an application earlier filed in the Korean Intellectual Property Office on Dec. 28, 2007 and there duly assigned Serial No. 10-2007-0140672.

### BACKGROUND OF THE INVENTION

1. Field of the Invention

The present invention relates to a field emission surface light source apparatus and a method of fabricating the same, and more particularly, to a field emission surface light source apparatus that can be fabricated using a screen printing method without a photomask process, and a method of fabricating the same.

2. Description of the Related Art

In general, flat panel displays can be largely classified into emissive and non-emissive displays. For example, examples of the emissive displays include cathode ray tubes (CRTs), plasma display panels (PDPs), field emission displays (FEDs), etc, and examples of the non-emissive displays include liquid crystal displays (LCDs). The non-emissive displays such as LCDs cannot emit light by themselves to form images and thus require additional surface light source apparatuses that are generally called backlight units.

Conventional backlight units have been fabricated using a plurality of line light sources such as cold cathode fluorescent lamps (CCFLs) or a plurality of point light sources such as light emitting diodes (LEDs). However, in general, fabricating cost of such backlight units increases, and the backlight units consume a large amount of power. In particular, the backlight units cannot secure the uniformity of brightness due to the tendency of increasing sizes of LCDs.

Surface light source apparatuses using carbon nano tube (CNT) emitters have been developed. Such surface light source apparatuses using CNT emitters operate according to a similar method to a method by which FEDs operate. Thus, the surface light source apparatuses are also referred to as field emission surface light source apparatuses. Such a field emission surface light source apparatus basically has a structure in which cathode electrodes alternate with gate electrodes on a base substrate such glass, and CNT emitters are formed on sides or upper surfaces of the cathode electrodes. Also, anode electrodes and a fluorescent layer are formed on a transparent substrate, and the transparent substrate is disposed opposite to the base substrate. As a result, electrons emitted from the CNT emitters advance toward the anode electrodes and then crash into the fluorescent layer to generate light.

In such a field emission surface light source apparatus, cathode electrodes, gate electrodes, and CNT emitters may be sequentially deposited on a base substrate using a photomask process. Alternatively, they may be sequentially coated on the base substrate using a screen printing method. In general, if the photomask process is used, process errors can be reduced, and the field emission surface light source apparatus can be fabricated in a very minute structure. However, fabricating cost can increase. If the screen printing method is used, a surface light source apparatus having a large area can be relatively easily fabricated, and fabricating cost can decrease. However, reductions in distances between the CNT emitters and gates are limited. As a result, an operating voltage is high. For example, an operating voltage of a field emission surface light source apparatus fabricated by a screen printing method is generally about 300 V or more.

### SUMMARY OF THE INVENTION

The present invention provides a field emission surface light source apparatus that can be fabricated using a screen printing method without a photomask process, and that have a lower operating voltage, and a method of fabricating the same.

According to an aspect of the present invention, there is provided a field emission surface light source apparatus including a transparent substrate, a base substrate having an upper surface that faces the transparent substrate, a plurality of gate electrodes formed on the upper surface of the base substrate, an insulating layer formed on the upper surface of the base substrate and covering the gate electrodes, a plurality of emitters formed on an upper surface of the insulating layer, and a fluorescent layer formed on a lower surface of the transparent substrate. The fluorescent layer faces the emitters.

The plurality of emitters may alternate with the plurality of gate electrodes. The emitters may simultaneously perform functions of emitting electrons and functions of cathode electrodes. The emitters are carbon nano tube (CNT) emitters.

A thickness of the insulating layer may be between 2 μm and 20 μm.

Each of the gate electrodes, the insulating layer, and the emitters may be formed by a screen printing method.

According to another aspect of the present invention, there is provided a method of fabricating a field emission surface light source apparatus. The method includes steps of applying metal paste in a bar-shaped pattern on a base substrate and firing the metal paste to form gate electrodes, applying insulator paste on the base substrate and firing the insulator paste to form an insulating layer that covers the gate electrodes, applying conductive paste in a bar-shaped pattern on the insulating layer and firing the conductive paste to form emitters, and disposing a transparent substrate comprising a fluorescent layer formed on a surface of the transparent substrate. The fluorescent layer faces the emitters.

The emitters may alternate with the gate electrodes.

Each of the metal paste, the insulator paste, and the conductive paste may be formed by a screen printing method.

The metal paste may be silver (Ag) paste.

The conductive paste may be conductive carbon nano tube (CNT) paste.

The method may further include activating CNTs included in the emitters in order to make the CNTs stand perpendicular to a surface of the emitters.

According to another aspect of the present invention, there is provided an image display apparatus including: a backlight unit; and a display panel forming an image using light provided from the backlight unit. Here, the backlight unit may be the field emission surface light source apparatus.

The display panel may include a liquid crystal display (LCD) panel.

The image display apparatus may further include a diffusion plate disposed between the backlight unit and the display panel to diffuse light emitted from the backlight unit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic perspective view of electrode structures formed on a base substrate of a field emission surface light source apparatus according to an embodiment of the present invention;

FIG. 2 is a schematic cross-sectional view of a field emission surface light source apparatus according to an embodiment of the present invention;

FIG. 3 is a graph illustrating a relationship between current (I) and voltage (V) in the field emission surface light source apparatus of FIG. 2; and

FIG. 4 is a schematic cross-sectional view of an image display apparatus using the field emission surface light source apparatus of FIG. 2 as a backlight unit, according to an embodiment of the present invention.

### DETAILED DESCRIPTION OF THE INVENTION

A field emission surface light source apparatus and a method of fabricating the field emission surface light source apparatus according to embodiments of the present invention will now be described in detail with reference to the attached drawings.

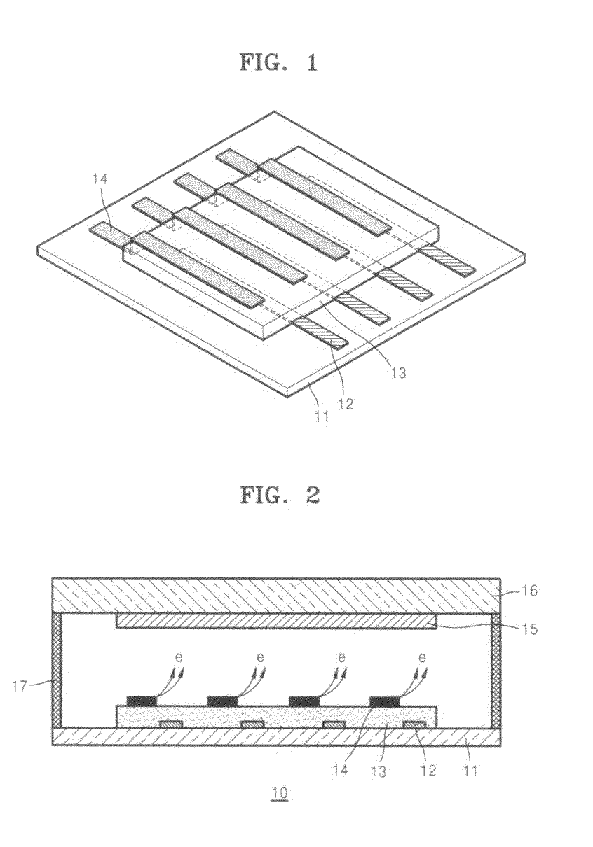

FIG. 1 is a schematic perspective view of electrode structures formed on a base substrate of a field emission surface light source apparatus according to an embodiment of the present invention.

Referring to FIG. 1, a plurality of gate electrodes 12 are formed side by side on a base substrate 11 that is formed of glass or the like. Here, the gate electrodes 12 have straight bar shapes that extend in one direction. An insulating layer 13 is formed on the base substrate 11 to cover the gate electrodes 12. For convenience, the insulating layer 13 is shown as being transparent in FIG. 1 to reveal the gate electrodes 12 formed underneath the insulating layer 13. However, the insulating layer 13 is not necessarily required to be transparent. The insulating layer 13 may be formed of SiO₂ or the like. A plurality of emitters 14 are formed side by side on the insulating layer 13, and have the same straight bar shapes as the gate electrodes 12 so as to extend in the same direction as the gate electrodes 12. Here, the emitters 14 can be carbon nano tube (CNT) emitters that are formed of CNTs. Also, in the present invention, the emitters 14 simultaneously perform both functions of cathode electrodes and electron emitters, and additional cathode electrodes are not necessary. In other words, cathode voltage is applied to the emitter 14, while the gate voltage is applied to the gate electrodes 12, in order to emit electrons from the emitter 14.

As shown in FIG. 1, portions of the gate electrodes 12 and portions of the emitters 14 are stretched beyond the insulating layer 13. The stretched portions of the gate electrodes 12 and the emitters 14 may be used as electrode pads for applying voltage or current to the gate electrodes 12 and the emitters 14.

FIG. 2 is a schematic cross-sectional view of a field emission surface light source apparatus 10 using the electrode structures illustrated in FIG. 1, according to an embodiment of the present invention. Referring to FIG. 2, the field emission surface light source apparatus 10 includes the base substrate 11 having the electrode structures illustrated in FIG. 1, and a transparent substrate 16 that faces the base substrate 11. A fluorescent layer 15 is formed on an inner surface (or a lower surface) of the transparent substrate 16 that faces the base substrate 11. Although not shown in the drawing, anode electrodes are disposed between the transparent substrate 16 and the fluorescent layer 15.

In this structure of the field emission surface light source apparatus 10, if a voltage is applied to the gate electrodes 12, electrons are emitted from surfaces of the emitters 14 due to a potential difference between the gate electrodes 12 and the emitters 14. The emitted electrons advance toward the fluorescent layer 15 through the anode electrodes (not shown) and then collide with the fluorescent layer 15. In this process, light is generated from the fluorescent layer 15. Here, a color of the generated light depends on a material of the fluorescent layer 15.

As previously described, in a conventional field emission surface light source apparatus, cathode electrodes alternate with gate electrodes on a base substrate. Also, emitters are formed on sides or upper surfaces of the cathode electrodes. Thus, if widths between the cathode electrodes and the gate electrodes are short, short-circuit may occur between the gate electrodes and the emitters, which can be caused by a process error. In order to prevent the short-circuit, if the cathode electrodes, the gate electrodes, and emitters are formed by a screen printing method, which has a relatively great process error, distances between the gate electrodes and the emitters should be large, and therefore an operating voltage increases.

However, according to the present invention, the gate electrodes 12 are disposed underneath the insulating layer 13, and the emitters 14 are disposed above the insulating layer 13 as shown in FIGS. 1 and 2. Therefore, short-circuit does not occur between the gate electrodes 12 and the emitters 14. As a result, even if a screen printing method is used, distances between gate electrodes 12 and the emitters 14 can be reduced regardless of an occurrence of a process error.

For this purpose, according to the present invention, the emitters 14 may alternate with the gate electrodes 12 disposed underneath the insulating layer 13. As shown in FIG. 2, the emitters 14 are disposed in spaces among the gate electrodes 12 disposed underneath the insulating layer 13. Here, the distances between the emitters 14 and the gate electrodes 12 may be as short as possible in order to lower the operating voltage of the field emission surface light source apparatus 10. The emitter 14 may not be disposed in a center of the space between the gate electrodes 12, but may be disposed biased toward left or right side of the space. In other words, the emitter 14 is arranged to be closer to one gate electrode than another gate electrode. However, if the emitters 14 overlap the gate electrodes 12, the number of electrons emitted from the sides of the emitters 14 may be reduced. Therefore, the emitter 14 can be arranged not overlapping any of the gate electrodes 12.

A method of fabricating the field emission surface light source apparatus 10 using the screen printing method, according to an embodiment of the present invention, will now be described in detail.

Metal paste is applied in a plurality of side-by-side bar-shaped patterns on the base substrate 11 using the screen printing method. In other words, the metal paste is applied in the same shapes as those of the gate electrodes 12 to be formed later. Here, the metal paste may be Ag paste. When the applied metal paste is fired to remove an organic binder from the metal paste, the gate electrodes 12 are formed. The gate electrodes 12 may each have a thickness between 1 μm and 2 μm.

Next, by the use of the screen printing method, the base substrate 11 is coated with insulator paste that covers the gate electrodes 12. Here, the insulator paste may be SiO₂ paste. When the insulator paste coated base substrate 11 is fired to remove an organic binder from the insulator paste, the hardened insulating layer 13 is formed. A thickness of the insulating layer 13 may be between about 2 μm and 20 μm.

Thereafter, conductive paste is applied in a plurality of side-by-side bar-shaped patterns on the insulating layer 13 by the screen printing method. In other words, the conductive paste is formed in the same shapes as those of the emitters 14 to be formed later. Here, the conductive paste may be conductive carbon nano tube (CNT) paste. The conductive CNT paste is applied in a manner that the locations of the bar-shaped patterns of the conductive CNT alternate with the gate electrodes 12 so that the emitters 14 to be formed later alternate with the gate electrodes 12 disposed underneath the insulating layer 13. When the applied conductive CNT paste is fired to remove an organic binder from the conductive CNT paste, the CNT emitters 14 are formed. Like the gate electrode 12, the CNT emitters 14 may each have a thickness between about 1 μm and 2 μm.

CNTs of the CNT emitters 14 do not stand perpendicular to a surface of the insulating layer 13 immediately after they are fired. Thus, the CNTs of the CNT emitters 14 may vertically stand through an activation process so as to easily emit the electrons. For example, in order to perform the activation process, an adhesive film such as a tape or the like may be attached onto the CNT emitter 14, and then detached from the fired CNT emitters 14. Alternatively, a roller, which has been surface-treated to have adhesion, may roll on the fired CNT emitters 14. During the process of rolling, portions of upper surfaces of the fired CNT emitters 14 tear off from the CNT emitters 14, and the CNTs remaining on the surface of the insulating layer 13 stand perpendicular to the surface of the insulating layer 13.

The base substrate 11 including the gate electrodes 12, the insulating layer 13, and the emitters 14 formed by the above-described method is disposed to face the transparent substrate 16 having the fluorescent layer 15 on its surface. Here, the base substrate 11 and the transparent substrate 16 are disposed in a manner that the fluorescent layer 15 faces the emitters 14. A barrier rib 17 is installed around edge portions of the based substrate 11 and the transparent substrate 16 and between the base and transparent substrates 11 and 16 that face each other according to the above-described method. The barrier rib 17 shields the inner space between the base substrate 11 and transparent substrate 16. As a result, fabrication of the field emission surface light source apparatus 10 is completed.

In the above-described method of fabricating the field emission surface light source apparatus 10, fabricating processes can be convenient, and thus fabricating cost can be reduced. In particular, it is easy to fabricating the field emission surface light source apparatus 10 having a large surface area. Therefore, the field emission surface light source apparatus 10 of the present invention can be used for a liquid crystal display (LCD) backlight unit, and is inexpensive compared to other large area flat light sources. As previously described, the operating voltage of the field emission surface light source apparatus 10 can be more lowered than a conventional field emission surface light source apparatus to improve the efficiency of the field emission surface light source apparatus 10.

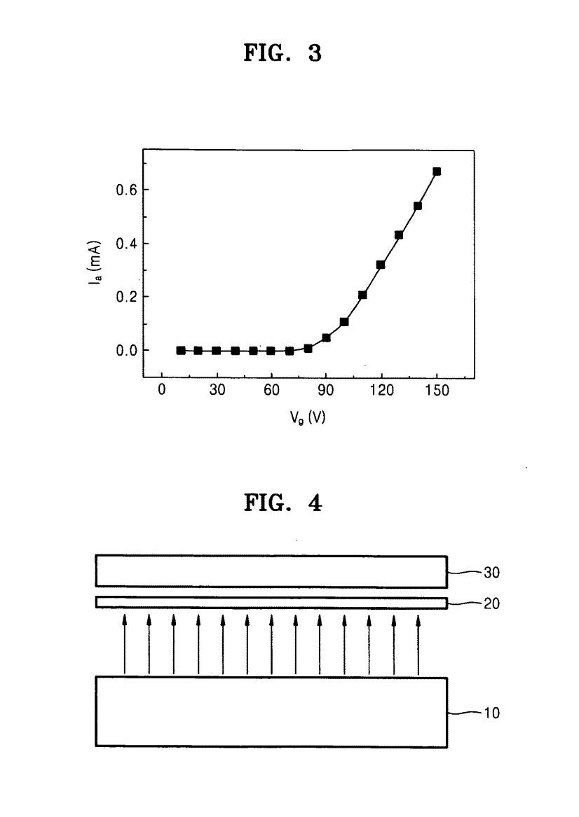

FIG. 3 is a graph illustrating a relationship between current (Ia) and voltage (Vg) of the field emission surface light source apparatus 10. Referring to FIG. 3, the emitters 14 start emitting electrons at an operating voltage of about 90 V. Thus, the operating voltage of the field emission surface light source apparatus 10 is greatly lower than the operating voltage of the conventional field emission surface light source apparatus

As shown in FIG. 4, the field emission surface light source apparatus 10 having the above-described structure can be adopted to an image display apparatus together with a non-emissive display panel 30 such as an LCD panel. FIG. 4 is a schematic cross-sectional view of an image display apparatus using the field emission surface light source apparatus 10 of FIG. 2 as a backlight unit, according to an embodiment of the present invention. The field emission surface light source apparatus 10 provides light to the non-emissive display panel 30, and the non-emissive display panel 30 forms an image using the provided light. Here, a diffusion plate 20 may be further installed between the field emission surface light source apparatus 10 and the non-emissive display panel 30 to diffuse the light emitted from the field emission surface light source apparatus 10.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A field emission surface light source apparatus comprising:
a transparent substrate;
a base substrate having an upper surface that faces the transparent substrate;
a plurality of gate electrodes formed on the upper surface of the base substrate;
an insulating layer formed on the upper surface of the base substrate and covering the gate electrodes;
a plurality of emitters formed on an upper surface of the insulating layer; and
a fluorescent layer formed on a lower surface of the transparent substrate, the fluorescent layer facing the emitters.

2. The field emission surface light source apparatus of claim 1, wherein the plurality of emitters alternate with the plurality of gate electrodes.

3. The field emission surface light source apparatus of claim 1, wherein each of the emitters simultaneously performs a function of emitting electrons and a function of cathode electrode.

4. The field emission surface light source apparatus of claim 1, wherein one of the emitters includes a carbon nano tube emitter.

5. The field emission surface light source apparatus of claim 1, wherein a thickness of the insulating layer is between 2 μm and 20 μm.

6. The field emission surface light source apparatus of claim 1, wherein each of the gate electrodes, the insulating layer, and the emitters is formed by a screen printing method.

7. A method of fabricating a field emission surface light source apparatus comprising:
applying metal paste in a bar-shaped pattern on a base substrate and firing the metal paste to form gate electrodes;
applying insulator paste on the base substrate and firing the insulator paste to form an insulating layer that covers the gate electrodes;
applying conductive paste in a bar-shaped pattern on the insulating layer and firing the conductive paste to form emitters; and
disposing a transparent substrate comprising a fluorescent layer formed on a surface of the transparent substrate, the fluorescent layer facing the emitters.

8. The method of claim 7, wherein the emitters alternate with the gate electrodes.

9. The method of claim 7, wherein each of the metal paste, the insulator paste, and the conductive paste is formed by a screen printing method.

10. The method of claim 7, wherein the metal paste includes silver (Ag) paste.

11. The method of claim 7, wherein the conductive paste includes conductive carbon nano tube (CNT) paste.

12. The method of claim 11, further comprising activating CNTs included in the emitters in order to make the CNTs stand perpendicular to a surface of the emitters.

13. An image display apparatus comprising:
a display panel forming an image; and
a backlight unit illuminating the display panel, the backlight unit comprises:
a transparent substrate;
a base substrate having an upper surface that faces the transparent substrate;
a plurality of gate electrodes formed on the upper surface of the base substrate;
an insulating layer formed on the upper surface of the base substrate and covering the gate electrodes;
a plurality of emitters formed on an upper surface of the insulating layer; and
a fluorescent layer formed on a lower surface of the transparent substrate, the fluorescent layer facing the emitters.

14. The image display apparatus of claim 13, wherein the display panel includes a liquid crystal display panel.

15. The image display apparatus of claim 13, further comprising a diffusion plate disposed between the backlight unit and the display panel to diffuse light emitted from the backlight unit.
